(19) United States
(12) Patent Application Publication
(10) Pub. No.: US 2009/0048319 A1
(43) Pub. Date: Feb. 19, 2009

(54) Method of Using a Micronutrient as Safener for a Triazole for Controlling Harmful Fungi

(76) Inventors: Harald Kohle, Bobenheim (DE); Martin P. Mascianica, Chapel Hill, NC (US); Albert C. Everson, Cary, NC (US); Thomas J. Holt, Holly Springs, NC (US); Ted R. Berdinelli, Durham, NC (US); Charles W. Finch, Gerner, NC (US)

Correspondence Address: BIRCH STEWART KOLASCH & BIRCH, PO BOX 747, FALLS CHURCH, VA, 22040-0747, US

(21) Appl. No.: 12/223,879

(22) PCT Filed: Feb. 7, 2007
(86) PCT No.: PCT/EP2007/051153

§ 371 Date: Aug. 12, 2008

Related U.S. Application Data
(60) Provisional application No. 60/772,907, filed on Feb. 14, 2006.

(51) Int. Cl. A01N 43/647; A01P 3/00

(52) U.S. Cl. 514/383

(57) ABSTRACT

A method of using a micronutrient selected from the group consisting of salts and adducts of Mg, Ca, B, Mn, Fe, Co and Zn and Mo as a safener for a triazole, selected from the group consisting of azaconazole, bitertanol, bromuconazole, cyproconazole, difenoconazole, diniconazole, enilconazole, epoxiconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triadimefon and triticonazole or salts or adducts thereof for controlling harmful fungi.

The present invention relates to a method of using a micronutrient selected from the group consisting of salts and adducts of Mg, Ca, B, Mn, Fe, Co, Zn and Mo as a safener for a triazole, selected from the group consisting of azaconazole, bitertanol, bromuconazole, cyproconazole, difenoconazole, diniconazole, enilconazole, epoxiconazole, fenbuconazole, fluquinconazole, flusilazole, flutriafol, hexaconazole, imibenconazole, ipconazole, metconazole, myclobutanil, penconazole, propiconazole, prothioconazoole, simeconazole, tebuconazole, tetraconazole, triadimenol, triadimefon and triticonazole, or salts or adducts thereof for controlling harmful fungi.

Moreover, the invention relates to a method for controlling harmful fungi using mixtures of the micronutrient and the triazole and to the use of the micronutrient and the triazole for preparing such mixtures, and also to compositions comprising these mixtures.

Montford, F. et al., Pesticide Science 46(4), 1996, 1996, pp. 315-322 discloses, that a negative effect on plant growth may occur when a triazole such as triticonazole is used for treating seed or crop plants. A negative effect dring the treatment with triticonazole may be a strongly reduced longitudinal growth, for example. This effect has been described for the crop plant wheat.

It was an object of the present invention to provide a safener which eliminates the negative effects of the triazole with respect to plant growth, at the same fungicidal action.

We have found that this object is achieved by the method, defined at the outset, of a micronutrient as safener for a triazole for controlling harmful fungi. Moreover, we have found that the micronutrient and the triazole can be applied simultaneously, that is jointly or separately. Furthermore, it has been found that a micronutrient and a triazole can be used for preparing a composition.

Micronutrients such as metal salts are described in Arnold Finck, Dünger und Düngung, VCH Verlagsgesellschaft mbH, Weinheim, 1989.

Metal containing adducts include also metal containing compounds and complexes and are known and disclosed as follows:

mancozeb, (U.S. Pat. No. 3,379,610)

maneb, manganese ethylenebis(dithiocarbamate) (U.S. Pat. No. 2,504,404);

metiram, zinc ammoniate ethylenebis (dithiocarbamate) (U.S. Pat. No. 3,248,400);

propineb, zinc propylenebis(dithiocarbamate) polymer (BE 611 960);

ferbam, iron(3+) dimethyldithiocarbamate (U.S. Pat. No. 1,972,961);

ziram, zinc bis (dimethyldithiocarbamate); CAS RN [137-30-4]

zineb, zinc ethylenebis(dithiocarbamate) (U.S. Pat. No. 2,457,674);

Triazoles their preparation and their action against harmful fungi are generally known (cf.: http://www.hclrss.demon.co.uk/index.html); they are commercially available.

Azaconazol 1-[[2-(2,4-dichlorophenyl)-1,3-dioxolan-2-yl] methyl]-1H-1,2,4-triazol CAS RN [50207-31-0]

bitertanol, β-([1,1′-biphenyl]-4-yloxy)-α-(1,1-dimethylethyl)-1H-1,2,4-triazole-1-ethanol (DE 23 24 020),

bromuconazole, 1-[[4-bromo-2-(2,4-dichlorophenyl)tetrahydro-2-furanyl]methyl]-1H-1,2,4-triazole (Proc. 1990 Br. Crop. Prot. Conf.-Pests Dis. Vol. 1, p. 459),

cyproconazole, 2-(4-chlorophenyl)-3-cyclopropyl-1-[1,2,4]triazol-1-ylbutan-2-ol (U.S. Pat. No. 4,664,696);

difenoconazole, 1-{2-[2-chloro-4-(4-chlorophenoxy)phenyl]-4-methyl-[1,3]dioxolan-2-ylmethyl}-1H-[1,2,4]triazole (GB-A 2 098 607);

diniconazole, (βE)-β-[(2,4-dichlorophenyl)methylene]-α-(1,1-dimethylethyl)-1H-1,2,4-triazole-1-ethanol (Noyaku Kagaku, 1983, Vol. 8, p. 575),

enilconazole (imazalil), 1-[2-(2,4-dichlorophenyl)-2-(2-propenyloxy)ethyl]-1H-imidazole (Fruits, 1973, Vol. 28, p. 545);

epoxiconazole, (2RS,3SR)-1-[3-(2-chlorophenyl)-2,3-epoxy-2-(4-fluorophenyl)propyl]-1H-1,2,4-triazole (EP-A 196 038);

fluquinconazole, 3-(2,4-dichlorophenyl)-6-fluoro-2-[1,2,4]triazol-1-yl-3H-quinazolin-4-one (Proc. Br. Crop Prot. Conf.-Pests Dis., 5-3, 411 (1992));

fenbuconazole, α-[2-(4-chlorophenyl)ethyl]-α-phenyl-1H-1,2,4-triazole-1-propanenitrile (Proc. 1988 Br. Crop Prot. Conf.-Pests Dis. Vol.1, p. 33),

flusilazole, 1-{[bis-(4-fluorophenyl)methylsilanyl]methyl}-1H-[1,2,4]triazole (Proc. Br. Crop Prot. Conf.-Pests Dis., 1, 413 (1984));

flutriafol, α-(2-fluorophenyl)-α-(4-fluorophenyl)-1H-1,2,4-triazole-1-ethanol (EP 15 756),

hexaconazole, 2-(2,4-dichlorophenyl)-1-[1,2,4]triazol-1-ylhexan-2-ol [CAS-RN 79983-71-4];

imibenconazole, (4-chlorophenyl)methyl N-(2,4-dichlorophenyl)-1H-1,2,4-triazole-1-ethaneimidothioate (Proc. 1988 Br. Crop Prot. Conf.-Pests Dis. Vol. 2, p. 519),

ipconazole, 2-[(4-chlorophenyl)methyl]-5-(1-methylethyl)-1-(1H-1,2,4-triazol-1-yl-methyl)cyclopentanol (EP 267 778),

metconazole, 5-(4-chlorobenzyl)-2,2-dimethyl-1-[1,2,4]triazol-1-ylmethylcyclopentanol (GB 857 383);

myclobutanil, 2-(4-chlorophenyl)-2-[1,2,4]triazol-1-ylmethylpentanenitrile [CAS RN 88671-89-0];

penconazole, 1-[2-(2,4-dichlorophenyl)pentyl]-1H-[1,2,4]triazole (Pesticide Manual, 12th Ed. (2000), page 712);

propiconazole, 1-[[2-(2,4-dichlorophenyl)-4-propyl-1,3-dioxolan-2-yl]methyl]-1H-1,2,4-triazole (BE 835 579),

prothioconazole, 2-[2-(1-chlorocyclopropyl)-3-(2-chlorophenyl)-2-hydroxypropyl]-2,4-dihydro-[1,2,4]triazol-3-thione (WO 96/16048);

simeconazole, α-(4-fluorophenyl)-α-[(trimethylsilyl)methyl]-1H-1,2,4-triazole-1-ethanol [CAS RN 149508-90-7],

triadimefon, 1-(4-chlorophenoxy)-3,3-dimethyl-1-(1H-1,2,4-triazol-1-yl)-2-butanone;

triadimenol, β-(4-chlorophenoxy)-α-(1,1-dimethylethyl)-1H-1,2,4-triazole-1-ethanol;

tebuconazole, 1-(4-chlorophenyl)-4,4-dimethyl-3-[1,2,4]triazol-1-ylmethylpentan-3-ol (EP-A 40 345);

tetraconazole, 1-[2-(2,4-dichlorophenyl)-3-(1,1,2,2-tetrafluorethoxy)propyl]-1H-1,2,4-triazole (EP 234 242),

triticonazole, (5E)-5-[(4-chlorophenyl)methylene]-2,2-dimethyl-1-(1H-1,2,4-triazol-1-ylmethyl)cyclopentanol (FR 26 41 277),

Owing to the basic character of its nitrogen atoms, the compound II is capable of forming salts or adducts with inorganic or organic acis and with metal ions, respectively.

Examples of inorganic acids are hydrohalic acids, such as hydrogen fluoride, hydrogen chloride, hydrogen bromide and hydrogen iodide, carbonic acid, sulphuric acid, phosphoric acid and nitric acid.

Suitable organic acids are, for example, formic acid and alkanoic acids, such as acetic acid, trifluoroacetic acid trichloroacetic acid and propionic acid, and also glycolic acid, thiocyanic acid, lactic acid, succinic acid, citric acid, benzoic acid, cinnamic acid, oxalic acid, alkylsulfonic acids (sulfonic acids having straight-chain or branched alkyl radicals of 1 to 20 carbon atoms), arylsulfonic acids or disulfonic acids (aromatic radicals, such as phenyl and naphthyl, which carry one or two sulfonic acid groups), alkylphosphonic acids (phosphonic acids having straight-chain or branched alkyl radicals of 1 to 20 carbon atoms), arylphosphonic acids or diphosphonic acids (aromatic radicals, such as phenyl and naphthyl, which carry one or two phosphoric acid radicals), where the alkyl or aryl radicals may carry further substituents, for example p-toluenesulfonic acid, salicylic acid, p-aminosalicylic acid, 2-phenoxybenzoic acid, 2-acetoxybenzoic acid, etc.

Suitable metal ions are in particular the ions of the elements of the second main group, in particular calcium and magnesium, of the third and fourth main group, in particular aluminum, tin and lead and also of the elements of transition groups one to eight, in particular chromium, manganese, iron, cobalt, nickel, copper, zinc, and others. Particular preference is given to the metal ions of the elements of transition groups of the fourth period. The metal ions can be present in the various valencies that they can assume.

Suitable micronutriens include salts or adducts of metal cations of Mg, Ca, Mn, Fe, Co, Zn and Mo with anions of inorganic or organic acids as described above and B in form of metal salts of H₂BO₃− and HBO₃²⁻, boric acid and salts of tetraborate and polyborate.

Preferred are metal salts of cations of Mg, Ca, Mn, and Zn with anions such as chloride, bromide, sulphate, carbonate, hydrogencarbonate, phosphate, phosphite, hydrogenphosphate, hydrogenphosphite, formiate and acetate. In addition sodium—and calciumborate, sodium tetraborate (borax), sodium polyborate and boric acid.

In particular preferred are metal salts of cations of Mn and Zn with anions such as chloride, bromide, carbonate and phosphate and sodium—and calciumborate, sodium tetraborate and boric acid.

Preferred metal adducts or complexes are mancozeb, maneb, metiram, ferbam, propineb, zineb and ziram.

In particular preferred are mancozeb, maneb, metiram, propineb, zineb and ziram.

Especially preferred are mancozeb and maneb.

The following combinations of a safener with a triazole are preferred.

Mancozeb as a safener for epoxiconazole, fluqiunconazole, metconazole, prothioconozale, tebuconazole or triticonozole.

Maneb as a safener for epoxiconazole, fluqiunconazole, metconazole, prothioconozale, tebuconazole or triticonozole

Metiram as a safener for epoxiconazole, fluqiunconazole, metconazole, prothioconozale, tebuconazole or triticonozole

Ferbam as a safener for epoxiconazole, fluqiunconazole, metconazole, prothioconozale, tebuconazole or triticonozole

Zineb as a safener for epoxiconazole, fluqiunconazole, metconazole, prothioconozale, tebuconazole or triticonozole

Ziram as a safener for epoxiconazole, fluqiunconazole, metconazole, prothioconozale, tebuconazole or triticonozole

The following triazoles in combination with the safener of the present invention are preferred.

Epoxiconazole, fluquinconazole, metconazole, prothioconazole, metconazole, tebuconazole and triticonazole.

Especially preferred are epoxiconazole, fluquinconazole, metconazole, tebuconazole and triticonazole.

Further preferred are metconazole and triticonazole.

In particular preferred is metconazole.

As described at the outset, in many crops, dressing of the seed with fungicides delays or reduces emergence and results in a poorer establishment of the stand when the cultivation is started.

The method of use of the mixtures of the micronutrient and the triazole, or the simultaneous, that is joint or separate, use of one of the micronutrient and the triazole, is distinguished in that the negative effects of a triazole on the plants do not occur, or are not as pronounced. In addition, the mixtures have excellent activity against a broad spectrum of phytopathogenic fungi, in particular from the classes of the Ascomycetes, Basidiomycetes, Deuteromycetes and Peronosporomycetes (syn. Oomycetes). Some of them are systemically active and can be used in crop protection as foliar fungicides, as fungicides for seed dressing and as soil fungicides.

They are particularly important for controlling a multitude of fungi on various cultivated plants, such as bananas, cotton, vegetable species (for example cucumbers, beans, tomatoes and cucurbits), barley, grass, oats, coffee, potatoes, corn, fruit species, rice, rye, legumes (for example soy beans, peas, beans, lentils), grapevines, wheat, ornamental plants, sugar cane and also on a large number of seeds.

They can be used in plants, which are tolerant against insects and fungi by cultivation including genetic methods.

In addition they are suitable for controlling Botryosphaeria species, Cylindrocarpon species, Eutypa lata, Neonectria liriodendri and Stereum hirsutum, which are active against the vine or their roots.

They are especially suitable for controlling the following plant diseases:
Alternaria species on vegetables, rapeseed, sugar beet, fruit, rice, soybeans and potatoes (e.g. A. solani or A. alternata) and tomatoes (e.g. A. solani or A. alternata) and Alternaria ssp. on wheat,
Aphanomyces species on sugar beet and vegetables,
Ascochyta species on cereals and vegetables, e.g. Ascochyta tritici on wheat,
Bipolaris and Drechslera species on corn, cereals, rice and lawns, e.g. D. maydis on corn,
Blumeria graminis (powdery mildew) on cereals (e.g. wheat or barley),
Botrytis cinerea (gray mold) on strawberries, vegetables, flowers, grape vines and wheat,
Bremia lactucae on lettuce,
Cercospora species on corn, soybeans, rice, sugar beet and e.g. Cercospora sojina or Cercospora kikuchii on soybeans, Cladosporium herbarum on wheat,
Cochliobolus species on corn, cereals, rice (e.g., Cochliobolus sativus on cereals, Cochliobolus miyabeanus on rice),
Colletotricum species on soybeans and cotton, e.g. Colletotrichum truncatum on soybeans,
Corynespora cassiicola on soybeans,
Dematophora necatrix on soybeans,
Diaporthe phaseolorum on soybeans,
Drechslera species, Pyrenophora species on corn, cereals, rice and lawn, on barley (e.g. D. teres) and on wheat (e.g. D. triticirepentis),
Esca on grapes, caused by Phaeoacremonium chlamydosporium, Ph. Aleophilum and Formitipora punctata (syn. Phellinus punctatus),
Elsinoe ampelina on grapes,
Epicoccum ssp. on wheat,
Exserohilum species on corn,
Erysiphe cichoracearum and Sphaerotheca fuliginea on cucurbits,
Fusarium and Verticillium species on various plants, e.g. F. graminearum or F. culmorum on cereals (e.g. wheat or barley) or e.g. F. oxysporum on tomatoes and Fusarium solani on soybeans,
Gaeumanomyces graminis on cereals (e.g. wheat or barley),
Gibberella species on cereals and rice (e.g., Gibberella fujikuroi on rice),
Glomerella cingulata on grapes and other plants,
Grain staining complex on rice,
Guignardia budwelli on grapes,
Helminthosporium species on corn and rice,
Isariopsis clarispora on grapes,
Macrophomina phaseolina on soybeans,
Michrodochium nivale on cereals,
Microsphaera diffusa on soybeans,
Mycosphaerella species on cereals, bananas and peanuts, like e.g. M. graminicola on wheat or M. fijiensis on bananas,
Peronospora species on cabbage (e.g. P. brassicae), onions (e.g. P. destructor) and e.g. Peronospora manshurica on soybeans,
Phakopsara pachyrhizi and Phakopsara meibomiae on soybeans,
Phomopsis species on soybeans (e.g. Phomopsis phaseoli), sunflowers and grapes (e.g. P. viticola),
Phytophthora species on different plants, e.g. P. capsici on paprika, P. megasperma on soybeans, Phytophthora infestans on potatoes and tomatoes,
Plasmopara viticola on grapevines,
Podosphaera leucotricha on apples,
Pseudocercosporella herpotrichoides on cereals (wheat or barley),
Pseudoperonospora species on hops (e.g. P. humill) and cucurbits (e.g. P. cubensis),
Pseudopezicula tracheiphilai on grapes,
Puccini species on different plants, e.g. P. triticina, P. striformius, P. hordei or P. graminis on cereals (e.g. wheat or barley) or on asparagus (e.g. P. asparagi),
Pyricularia oryzae, Corticium sasakii, Sarocladium oryzae, S. attenuatum, Entyloma oryzae on rice,
Pyrenophora tritici-repentis on wheat or Pyrenophora teres on barley,
Pyricularia grisea on lawns and cereals,
Pythium spp. on lawns, wheat, rice, corn, cotton, rapeseed, sunflowers, sugar beet, vegetables and other plants (e.g. P. ultiumum or P. aphanidermatum),
Rumularia collo-cygni on barley,
Rhizoctonia species on cotton, rice, potatoes, lawns, corn, rapeseed, potatoes, sugar beet, vegetables and other plants, e.g. Rhizoctonia solani on soybeans or Rhizoctonia cerealis on wheat or barley, Rhynchosporium secalis on barley, rye and triticale,
Sclerotinia species on rapeseed and sunflowers and e.g. Sclerotinia sclerotiorum or Sclerotinia rolfsii on soybeans, Septoria glycines on soybeans,
Septoria tritici and Stagonospora nodorum on wheat,
Erysiphe (syn. Uncinula) necator on grapevines,
Setospaeria species on corn and lawns,
Sphacelotheca reilinia on corn,
Stagonospora nodorum on wheat,
Thievaliopsis species on soybeans and cotton,
Tilletia species on cereals,
Typhula incarnata on wheat or barley,
Ustilago species on cereals, corn and sugar beet, and
Venturia species (scab) on apples and pears.

The micronutrient and the triazole can also be used for controlling harmful fungi such as Paecilomyces variotii in the protection of materials (for example wood, paper, paint dispersions, fibers or fabrics) and in the protection of stored products.

The micronutrient and the triazole can be applied simultaneously, that is jointly or separately, or in succession, the sequence, in the case of separate application, generally not having any effect on plant growth and the result of the control measures.

During use according to the invention, it is preferred to employ the pure micronutrient and the triazole, to which further active compounds against harmful fungi or against other pests, such as insects, arachnids or nematodes, or else herbicidal or growth-regulating active compounds or fertilizers can be added according to need.

Usually, mixtures of the micronutrient and the triazole are used. However, in certain cases mixtures of the micronutrient and the triazole with, if appropriate, a plurality of active components may be advantageous, such as, for example, mixtures of the micro-nutrient and the triazole with further fungicides.

The mixing ratio (weight ratio) of the micronutrient and the triazole is chosen such that the described safener action occurs, for example micronutrient: triazole such as 100:1 to 1:100, in particular from 10:1 to 1:10, for example from 5:1 to 1:5, in particular from 3:1 to 1:3, preferably from 2:1 to 1:2. The safener action of the mixture manifests itself in that the negative effect of the triazole on the growth of the plants is absent or not as pronounced.

The further active components are, if desired, added in a ratio of from 20:1 to 1:20 to the micronutrient and the triazole.

Depending on the type of compound and the desired effect, the application rates of the mixtures used are, especially agricultural crop areas, from 5 g/ha to 2000 g/ha, preferably from 20 to 900 g/ha, in particular from 50 to 750 g/ha.

Correspondingly, the application rates for the micronutrient are generally from 1 to 1000 g/ha, preferably from 10 to 900 g/ha, in particular from 20 to 750 g/ha.

Correspondingly, the application rates for the triazole are generally from 1 to 1000 g/ha, preferably from 10 to 900 g/ha, in particular from 40 to 750 g/ha.

In the treatment of seed, application rates of mixture of micronutrient and the triazole are generally from 1 to 1000 g/100 kg of seed, preferably from 1 to 750 g/100 kg, in particular from 5 to 500 g/100 kg.

The use according to the invention of the micronutrient and the triazole in the method for controlling harmful fungi is carried out by the separate or joint application of the micronutrient and the triazole or a mixture of the micronutrient and the triazole by spraying or dusting the seeds, the plants or the soil before or after sowing of the plants or before or after emergence of the plants.

When using the micronutrient and the triazole according to the invention, they can be converted into the customary formulations, for example solutions, emulsions, suspensions, dusts, powders, pastes and granules. The use form depends on the particular intended purpose; in each case, it should ensure a fine and even distribution of the micronutrient and the triazole.

The formulations are prepared in a known manner, for example by extending the active compound with solvents and/or carriers, if desired using emulsifiers and dispersants. Solvents/auxiliaries suitable for this purpose are essentially:
water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used,
carriers such as ground natural minerals (for example kaolins, clays, talc, chalk) and ground synthetic minerals (for example highly disperse silica, silicates); emulsifiers such as nonionogenic and anionic emulsifiers (for example polyoxyethylene fatty alcohol ethers, alkylsulfonates and arylsulfonates) and dispersants such as lignosulfite waste liquors and methylcellulose.

Suitable for use as surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone and water.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the micronutrient and the triazole. The micronutrient and the triazole are employed in a purity of from 90% to 100%, preferably 95% to 100% (according to NMR spectrum).

The following are examples of formulations: 1. Products for Dilution With Water

A) Water-Soluble Concentrates (SL)

10 parts by weight of the micronutrient and the triazole according to the invention are dissolved in 90 parts by weight of water or of a water-soluble solvent. As an alternative, wetting agents or other auxiliaries are added. The active compound dissolves upon dilution with water. This gives a formulation having an active compound content of 10% by weight.

B) Dispersible Concentrates (DC)

20 parts by weight of the micronutrient and the triazole according to the invention are dissolved in 70 parts by weight of cyclohexanone with addition of 10 parts by weight of dispersant, for example polyvinylpyrrolidone. Dilution with water gives a dispersion. The active compound content is 20% by weight.

C) Emulsifiable Concentrates (EC)

15 parts by weight of the micronutrient and the triazole according to the invention are dissolved in 75 parts by weight of xylene with addition of calcium dodecylbenzenesulfonate and castor oil ethoxylate (in each case 5 parts by weight). Dilution with water gives an emulsion. The formulation has an active compound content of 15% by weight.

D) Emulsions (EW, EO)

25 parts by weight of the micronutrient and the triazole according to the invention are dissolved in 35 parts by weight of xylene with addition of calcium dodecylbenzenesulfonate and castor oil ethoxylate (in each case 5 parts by weight). This mixture is introduced into 30 parts by weight of water by means of an emulsifying machine (e.g. Ultraturrax) and made into a homogeneous emulsion. Dilution with water gives an emulsion. The formulation has an active compound content of 25% by weight.

E) Suspensions (SC, OD)

In an agitated ball mill, 20 parts by weight of the micronutrient and the triazole according to the invention are comminuted with addition of 10 parts by weight of dispersants and wetting agents and 70 parts by weight of water or an organic solvent to give a fine active compound suspension. Dilution with water gives a stable suspension of the active compound. The active compound content in the formulation is 20% by weight.

F) Water-Dispersible Granules and Water-Soluble Granules (WG, SG)

50 parts by weight of the micronutrient and the triazole according to the invention are ground finely with addition of 50 parts by weight of dispersants and wetting agents and prepared as water-dispersible or water-soluble granules by means of technical appliances (for example extrusion, spray tower, fluidized bed). Dilution with water gives a stable dispersion or solution of the active compound. The formulation has an active compound content of 50% by weight.

G) Water-Dispersible Powders and Water-Soluble Powders (WP, SP)

75 parts by weight of the micronutrient and the triazole according to the invention are ground in a rotor-stator mill with addition of 25 parts by weight of dispersants, wetting agents and silica gel. Dilution with water gives a stable dispersion or solution of the active compound. The active compound content of the formulation is 75% by weight.

2. Products to be Applied Undiluted

H) Dustable Powders (DP)

5 parts by weight of the micronutrient and the triazole according to the invention are ground finely and mixed intimately with 95 parts by weight of finely divided kaolin. This gives a dustable product having an active compound content of 5% by weight.

J) Granules (GR, FG, GG, MG)

0.5 part by weight of the micronutrient and the triazole according to the invention is ground finely and associated with 99.5 parts by weight of carriers. Current methods are extrusion, spray-drying or the fluidized bed. This gives granules to be applied undiluted having an active compound content of 0.5% by weight.

K) ULV Solutions (UL)

10 parts by weight of the micronutrient and the triazole according to the invention are dissolved in 90 parts by weight of an organic solvent, for example xylene. This gives a product to be applied undiluted having an active compound content of 10% by weight.

The micronutrient and the triazole can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the micronutrient and the triazole, as such or dissolved in an oil or solvent, can be homogenized in water by means of a wetter, tackifier, dispersant or emulsifier. However, it is also possible to prepare concentrates composed of the micronutrient and the triazole, wetter, tackifier, dispersant or emulsifier and, if appropriate, solvent or oil, and such concentrates are suitable for dilution with water.

The concentrations of the micronutrient and the triazole in the ready-to-use preparations can be varied within relatively wide ranges. In general, they are from 0.0001 to 10%, preferably from 0.01 to 1%.

The micronutrient and the triazole may also be used successfully in the ultra-low-volume process (ULV), it being possible thereby to apply formulations comprising over 95% by weight of the micronutrient and the triazole, or even to apply the micronutrient and the triazole without additives.

Oils of various types, wetters, adjuvants, may be added to the micronutrient and the triazole, even, if appropriate, not until immediately prior to use (tank mix). These agents are typically admixed with the compositions according to the invention in a weight ratio of from 1:100 to 100:1, preferably from 1:10 to 10:1.

The micronutrient and the triazole or the mixtures or the corresponding formulations are applied by treating the harmful fungi, the plants, seeds, soils, areas, materials or spaces to be kept free from them with a fungicidally effective amount of the mixture or, in the case of separate application, of the micronutrient and the triazole. Application can be carried out before or after infection by the harmful fungi.

The safener action of the micronutrient and the triazole was demonstrated by the tests below.

Seeds were treated with the micronutrient and the triazole individually or with mixtures of the micronutrient and the triazole, and the development of the plants was then observed. When the mixtures were used, the negative effects of one or both mixing partners in the case of individual application were, if at all, observed at a reduced level.

Test 1

Test for Phytotoxicity at Soybean Plants

Several varieties of soybeans were cultivated for 6 weeks in the greenhouse at about 93 degrees F until they reached a size of about 5 trifoliates. Then they were sprayed with commercial formulations of metconazol (Caramba), mancozeb (Fore (Dow) 80 DF) and their mixture in the given rate. After 4 weeks the plant damage was assessed as % chlorosis of the leaf area of the middle leaves.

Variety GH3946

| | | Chlorosis (% leaf area) |
|---|---|---|
| Untreated | | 0 |
| Metconazol | 100 g/ha | 20 |
| Metconazol & Mancozeb | 100 g/ha & 2.24 kg/ha | 10 |

Variety USG 7443

| | | Chlorosis (% leaf area) |
|---|---|---|
| Untreated | | 0 |
| Metconazol | 100 g/ha | 5 |
| Metconazol & Mancozeb | 100 g/ha & 2.24 kg/ha | 0 |

Variety DKB 36-52

| | | Chlorosis (% leaf area) |
|---|---|---|
| Untreated | | 0 |
| Metconazol | 100 g/ha | 10 |
| Metconazol & Mancozeb | 100 g/ha & 2.24 kg/ha | 3 |

Test 2

Test for Phytotoxicity at Soybean Plants

Several varieties of soybeans were cultivated for 6 weeks in the greenhouse at about 93 degrees F until they reached a size of about 5 trifoliates. Then they were sprayed with commercial formulations of metconazol (Caramba), mancozeb (Fore (Dow) 80 DF) and their mixture in the given rate. After 4 weeks the plant damage was assessed as % necrosis of the leaf area of the middle leaves.

Variety RC 3624

| | | Necrosis (% leaf area) |
|---|---|---|
| Untreated | | 0 |
| Metconazol | 100 g/ha | 9 |
| Metconazol & Mancozeb | 100 g/ha & 2.24 kg/ha | 1 |

Variety DKB 38-52

| | | Necrosis (% leaf area) |
|---|---|---|
| Untreated | | 0 |
| Metconazol | 100 g/ha | 7 |
| Metconazol & Mancozeb | 100 g/ha & 2.24 kg/ha | 1 |

1-12. (canceled)

13. A method of using a micronutrient selected from the group consisting of mancozeb, maneb, metiram, ferbam, propineb, zineb and ziram as a safener for a triazole, selected from the group consisting of azaconazole, bitertanol, bromuconazole, cyproconazole, difenoconazole, diniconazole, enilconazole, epoxiconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triadimefon and triticonazole or salts or adducts thereof for controlling harmful fungi.

14. The method according to claim 13, wherein the micronutrient is selected from the group consisting of mancozeb, maneb, metiram, propineb, zineb and ziram.

15. The method according to claim 14, wherein the micronutrient is selected from the group consisting of mancozeb and maneb.

16. The method according to claim 13, wherein the triazole is selected from the group consisting of epoxiconazole, fluquinconazole, metconazole, prothioconazole, tebuconazole and triticonazole.

17. The method according to claim 13, wherein the weight ratio of the micronutrient to the triazole is from 100:1 to 1:100.

18. The method according to claim 13, which comprises treating the fungi, their habitat or the plants, seeds, soils, areas, materials or spaces to be kept free from them with the micronutrient and the triazole.

19. The method according to claim 18, wherein the micronutrient and the triazole according to claim 13 are applied simultaneously, that is together or separately, or in succession.

20. The method according to claim 18, wherein the micronutrient and the triazole according to claim 13 are applied in an amount of from 5 g/ha to 2000 g/ha.

21. The method according to claim 18, wherein the micronutrient and the triazole according to claim 13 are applied in an amount of from 1 g to 1000 g per 100 kg of seed.

22. A method of using the micronutrient and the triazole for preparing a composition suitable for controlling harmful fungi.

23. The method according to claim 22, wherein the composition comprises in addition to the micronutrient and the triazole a solid or liquid carrier.
